(19) United States
(12) Patent Application Publication
(10) Pub. No.: US 2024/0122252 A1
(43) Pub. Date: Apr. 18, 2024

(54) A Method for Controlling the Heating of a Susceptor of an Aerosol-Generating Device

(71) Applicant: JT International SA, Geneva (CH)

(72) Inventors: Branislav Zigmund, Vrbovce (SK); Stefan Lojek, Zilina (SK); Daniel Vanko, Krpelany (SK); Petr Konvicný, Roznov p.R. (CZ); Stanislav Sliva, Ostrava (CZ)

(73) Assignee: JT International SA, Geneva (CH)

(21) Appl. No.: 18/275,549

(22) PCT Filed: Feb. 4, 2022
(86) PCT No.: PCT/EP2022/052771

§ 371 Date: Aug. 2, 2023

(30) Foreign Application Priority Data
Feb. 5, 2021 (EP) 21155430.8

(51) Int. Cl. A24F 40/465; A24F 40/57

(52) U.S. Cl. CPC A24F 40/465; A24F 40/57

(57) ABSTRACT

A method for controlling the heating of a susceptor of an aerosol-generating device is described, the susceptor being inductively heated by an oscillating circuit driven by an inverter at an operating frequency. The method includes a power delivery mode of the aerosol-generating device, a step of updating the operating frequency being performed during the power delivery mode and including the following sub-steps: determining, using a controller, the resonant frequency of the oscillating circuit during heat of the susceptor; and setting, using the controller, the operating frequency at the determined resonant frequency. The updating step is continuously repeated during power delivery mode of the aerosol-generating device.

### TECHNICAL FIELD

The present disclosure relates generally to a method for controlling the heating of a susceptor of an aerosol-generating device and an aerosol-generating device comprising a controller adapted to implement said method.

### TECHNICAL BACKGROUND

An aerosol-generating device generally comprises at least one reservoir arranged to store an aerosol-generating product. The aerosol-generating product is heated, without burning, in order to generate an aerosol for inhalation.

The aerosol-generating product can be heated using different methods. One method consists in using induction heating. Such an aerosol-generating device thus comprises an induction heating system usually comprising an induction coil, an induction heatable susceptor and a power supply unit.

Thanks to the power supply unit or battery, electrical energy is provided to the induction coil. The induction coil thus generates an alternating electromagnetic field. The susceptor couples with the electromagnetic field and generates heat, which is transferred, for example by conduction, to the aerosol-generating product. Finally, the heated aerosol-generating product generates an aerosol.

For an optimized operating of the aerosol-generating device, there is a need to seek the highest possible energy efficiency during inductive heating.

WO2020020970A1 discloses for example a controller in an aerosol generating system for detecting a self-resonant frequency of an induction coil that inductively heats a susceptor of an aerosol-generating device. The controller further controls the operation of the aerosol-generating device based on the detected self-resonant frequency. This solution does not provide the highest energy efficiency when heating the susceptor.

The present disclosure aims at providing an improved method for controlling the inductive heating of a susceptor of an aerosol-generating device. More precisely, it aims at improving the energy efficiency when heating the susceptor.

### SUMMARY OF THE DISCLOSURE

The present disclosure thus relates to a method for controlling the heating of a susceptor of an aerosol-generating device, the susceptor being inductively heated by an oscillating circuit driven by an inverter at an operating frequency.

According to a first aspect of the present disclosure, the method comprises a power delivery mode of the aerosol-generating device, a step of updating the operating frequency being performed during the power delivery mode and comprising the following sub-steps:
determining, using a controller, the resonant frequency of the oscillating circuit during heat of the susceptor; and
setting, using the controller, the operating frequency at the determined resonant frequency.

The updating step being continuously repeated during power delivery mode of the aerosol-generating device.

By updating continuously the operating frequency of the oscillating circuit to set it at the resonant frequency, it is possible to obtain the most efficient heating of the susceptor.

The resonant frequency in the updating step may be determined by measuring the phase between the current of an inductance coil and the voltage of a capacitor of the oscillating circuit, the resonant frequency corresponding to the frequency obtained when the current and the voltage are at 90° phase shift.

The resonant frequency in the updating step may be determined by minimizing an error function calculated using measurements of electrical indicative values in the oscillating circuit.

The updating step may further comprise a sub-step of determination of the susceptor temperature based on the determined resonant frequency during the power delivery mode.

Thanks to this feature, it is possible to continuously monitor the temperature of the susceptor during the power delivery mode. This monitoring can be used for example to control the power supply to the inverter depending on the desired heating profile of the susceptor.

The method may further comprise a temperature identification mode of the aerosol-generating device.

The power delivery mode and the temperature identification mode may be alternated during operating of the aerosol-generating device.

The temperature identification mode may run at regular intervals of time.

The method may further comprise an initialization step comprising the following sub-steps:
determining an initial resonant frequency of the oscillating circuit when the susceptor is at ambient temperature; and
setting the operating frequency at the determined initial resonant frequency.

The temperature of the susceptor may be determined using a predetermined linear function between the resonant frequency of the oscillating circuit and the temperature of the susceptor, e.g. a predetermined linear function in which the resonant frequency at ambient temperature corresponds to the initial resonant frequency. The temperature of the susceptor may also be determined using a predetermined polynomial function between the resonant frequency of the oscillating circuit and the temperature of the susceptor.

This provides a simple and efficient method for determining the temperature of the susceptor based on the resonant frequency determined during the power delivery mode.
The resonant frequency in the initialization step may be determined by:
   sweeping the frequencies on a range;
   measuring an indicative electrical value in the oscillating circuit; and
   selecting the resonant frequency within said range when an extremum of said indicative electrical value is obtained.
According to a second aspect of the present disclosure, there is provided an aerosol-generating device comprising:
   an induction heatable susceptor;
   an oscillating circuit arranged to generate a time varying electromagnetic field for inductively heating the susceptor;
   an inverter configured to drive the oscillating circuit at an operating frequency; and
   a controller adapted to implement the method for controlling the heating of the susceptor as previously described.

The aerosol-generating device may further comprise a boost converter connected between a power supply unit and the inverter.

### BRIEF DESCRIPTION OF THE DRAWINGS

Other particularities and advantages of the present disclosure will also emerge from the following description.

In the accompanying drawings, given by way of non-limiting examples:

FIGS. 1a, 1b represent schematically part of an aerosol-generating device 1 according to two embodiments of the present disclosure;

FIG. 2a represents schematically the electronic circuitry of the aerosol-generating device;

FIG. 2b represents schematically a control loop system according to an embodiment of the present disclosure;

FIGS. 3a, 3b, 3c represent examples of oscillating circuits used for inductive heating in the aerosol-generating device;

FIG. 4a represents a theoretical example of an oscillating circuit that can be used for inductive heating in the aerosol-generating device;

FIG. 4b represents an equivalent circuit of the oscillating circuit of FIG. 4a;

FIGS. 4c, 4d represent a vector representation of currents in the oscillating circuit of FIG. 4b;

FIG. 5 represents a linear dependency between the resonant frequency of the oscillating circuit and the temperature of a susceptor of the aerosol-generating device;

FIG. 6 represents schematically a method for controlling the heating by induction of the susceptor of the aerosol-generation device; and

FIG. 7 represents an example of temperature control that can be implemented in the aerosol-generating device.

### DETAILED DESCRIPTION OF EMBODIMENTS

Embodiments of the present disclosure will now be described by way of example only and with reference to the accompanying drawings.

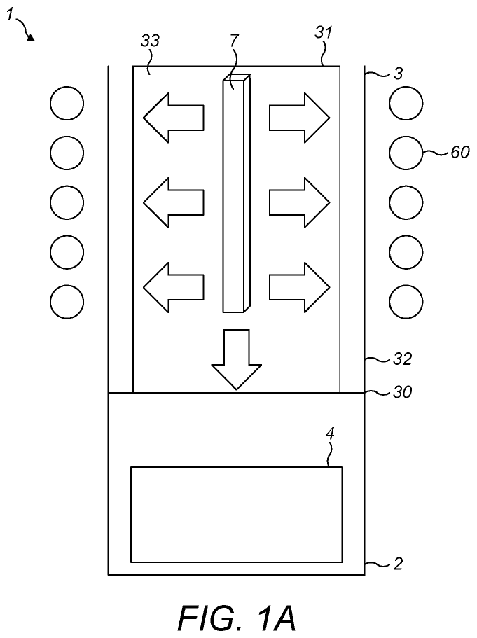

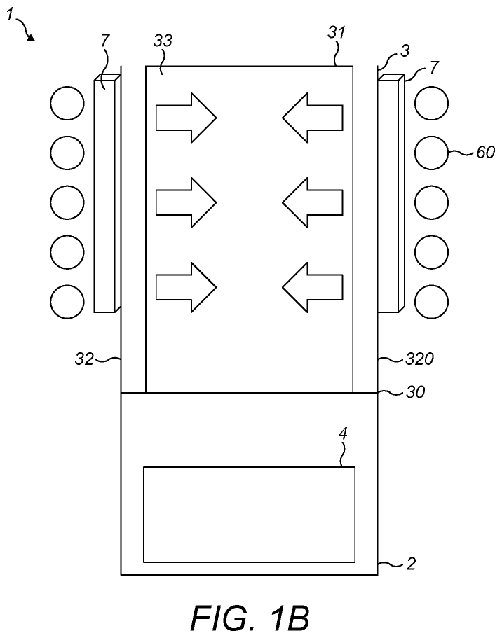

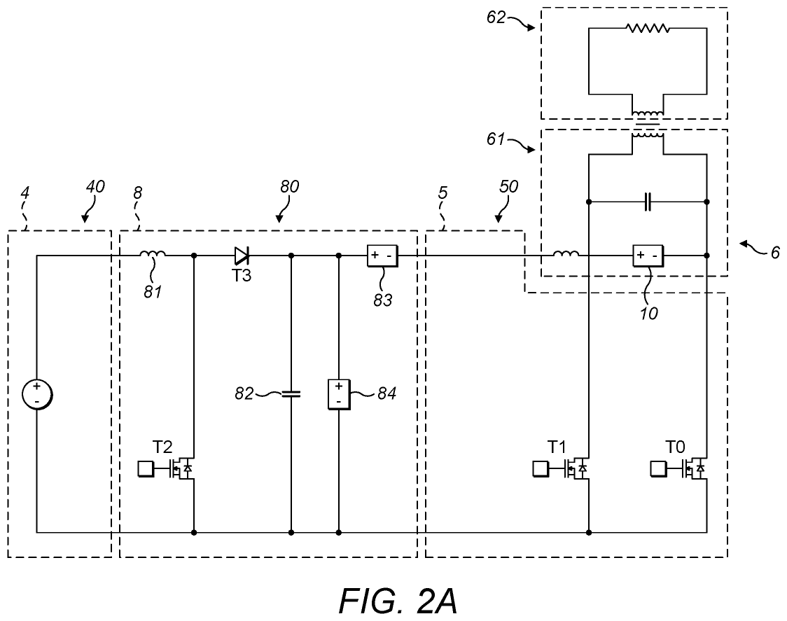

FIGS. 1a and 1b represent schematically part of an aerosol-generating device 1 according to two different embodiments of the present disclosure. Both FIGS. 1a, 1b show schematically the mechanical configuration of the aerosol-generating device, whereas FIG. 2a represents an example of the electronic circuitry of the aerosol-generating device.

An aerosol-generating device generally comprises a main body 2 and a cartridge 3.

The cartridge 3 comprises a first end 30 configured to engage with the body 2 and a second end 31 arranged as a mouthpiece portion (not shown) having a vapor outlet.

The cartridge 3 further comprises at least one reservoir 32 arranged to store an aerosol-generating product 33. The cartridge 3 may be disposable.

The reservoir 32 is arranged to receive a correspondingly shaped aerosol-generating product 33. The aerosol-generating product 33 and/or the reservoir 32 may be a disposable article or a stick.

The term aerosol-generating product is used to designate any material that is vaporizable in air to form an aerosol. Vaporization is generally obtained by a temperature increase up to the boiling point of the vaporization material, such as a temperature up to 400° C., preferably up to 350° C. The vaporizable material may, for example, be in liquid form, solid form, or in a semi liquid form. The vaporizable material thus comprises or consists of a liquid, tobacco, gel, or wax or the like, or any combination of these.

The mouthpiece is removably mounted to allow access to the reservoir for the purposes of inserting or removing the aerosol-generating product 33.

The aerosol-generating device comprises an induction heating system configured to enable the heating of the aerosol-generating product 33.

The induction heating system comprises a power supply unit or battery 4 as well as an inverter 5 and a controller 9 (visible on FIG. 2b), generally disposed in the body 2.

The inverter 5 is arranged to convert a direct current from the battery 4 into an alternating high-frequency current. The inverter 5 comprises here two switches or transistors, T0, T1. The transistors T0, T1 are operated at the same frequency and at a predetermined duty cycle. In particular, the duty cycle of the two transistors T0, T1 of the inverter 5 is equal to 50%.

The induction heating system further comprises an oscillating circuit 6. The oscillating circuit comprises an inductance provided by a coil 60.

The coil 60 is here a helical induction coil which extends around the reservoir 32. The induction coil 60 is energized by the power source unit and the controller.

The induction heating system also comprises one or more induction heatable susceptors 7. A susceptor is an element made in an electrically conducting material and used to heat a non-electrically conducting material or product.

The induction heatable susceptor 7 can be in direct or indirect contact with the aerosol-generating product 33, such that when the susceptor 7 is inductively heated by the induction coil 60, heat is transferred from the susceptor 7 to the aerosol-generating product, to heat the aerosol-generating product and thereby produce an aerosol.

In the example shown in FIG. 1a, the susceptor 7 extends within the reservoir 32 with the aerosol-generating product 33. The susceptor is preferably arranged inside the aerosol-generating product 33.

In another embodiment shown in FIG. 1b, the susceptor 7 extends outside the aerosol-generating product 33. The susceptor 7 preferably extends along lateral walls 320 of the reservoir 32.

The controller 9 is configured to operate other electronic components among which is the inverter 5.

The controller 9 is arranged to control the oscillating circuit, for example control the voltage delivered to the oscillating circuit from the battery 4, and the operating frequency fₒₚ at which the oscillating circuit is driven.

FIG. 2a represents the battery circuitry 40, the inverter circuitry 50, the oscillating circuit 6 comprising a coil circuit 61 and a susceptor circuitry 62.

The aerosol-generating device 1 also comprises here a boost converter 8, of which the circuitry 80 is represented at FIG. 2a. For some aerosol-generating devices, the boost converter may be omitted so that the inverter 5 is connected directly to the battery 4. Whether a boost converter is required may depend on the properties of the susceptor and the oscillating circuit. If the aerosol-generating device does not include a boost converter, the heating of the susceptor may be controlled by operating the inverter. For example, the inverter may be periodically enabled and disabled (or periodically controlled to be in an On-state and an Off-state) with a duty cycle that can be varied to control the heating of the susceptor. Such operation can be referred to as a “global” pulse width modulation (PWM) control scheme where the time for which the inverter is enabled (or “pulse width”) is varied. During the periods when the inverter is enabled (or in an On-state) the transistors T0, T1 of the inverter 5 can be operated at a predetermined duty cycle. Both transistors T0, T1 are turned off during the periods when the inverter is disabled (or in an Off-state)

The boost converter 8 is on the one part connected to the battery 4 and to the other part connected to the inverter 5.

The boost converter 8 is configured to step-up the voltage, i.e. to transform a DC voltage into a DC voltage of a higher value. More precisely, the boost converter 8 is configured to step-up voltage from an input voltage Vᵢₙ supplied from the power supply unit 4 to a higher output voltage Vₒᵤₜ delivered to the inverter 5.

The boost converter 8 is an advantageous solution for increasing voltage with minimal space.

A boost converter is a type of switch mode power supply. In particular, it uses a main switch, for example a transistor to turn part of the circuit on and off at a certain speed.

The boost converter 8 comprises an active switch T2 and a passive switch T3.

The active switch T2, or main switch, is here a MOSFET transistor (Metal-oxide Semiconductor Field Effect Transistor). The passive switch T3, or auxiliary switch, is here a diode. The boost converter is thus an asynchronous boost converter.

In another embodiment, the passive switch T3 can be a MOSFET transistor. The boost converter 8 can thus be a synchronous boost converter.

The boost converter 8 further comprises an inductor 81 and a capacitor 82.

The controller 9 is configured here to control the boost converter 8, in particular to control the output voltage delivered to the inverter 5.

FIG. 2b shows an example of a control loop system that can be used in the present disclosure. The controller 9 is connected on the one side to the inverter 5 and on the other side to the boost converter 8.

The controller 9 is for example a proportional-integral-derivative controller (PID controller).

For a more advanced control and better performance, other topologies or controller types can be used. The controller 9 can be for instance a model-based controller. Such a controller has the advantage of taking into account the dynamic response of the system which changes with operating conditions. The model-based controller yields significantly better performance and exhibits a much lower sensitivity to variation in system properties compared to a regular PID controller. It enables for instance a rapid ramping up or ramping down of the temperature when needed.

In yet another particular embodiment, the controller 9 can be a model-predictive controller or a model-based predictive controller. Such a controller is also able to represent the behaviour of a dynamic system and further uses a model of the system to make predictions about the system's future behaviour.

A type of hybrid or mixed control may also be used. For example, if the aerosol-generating device includes a boost converter 8, the boost converter may be controlled by the controller 9 for some operations of the aerosol-generating device (e.g., during pre-heating) while for other operations (e.g., during a vaping phase) the boost converter may be bypassed or disabled and the induction heating of the susceptor 7 is controlled by the inductor, e.g. using the “global” PWM control scheme mentioned above. During pre-heating, more power is needed and the boost converter 8 would be beneficial in providing a higher output voltage for the inverter 5. A higher voltage means a lower current is needed to achieve the same power, which can reduce losses. Afterwards, during a vaping phase, less power is needed and there is no need for the boost converter 8. Conducting losses can therefore be reduced by bypassing the boost converter 8.

The induction heating is commonly based on series, parallel or series-parallel resonant principle. The present aerosol-generating device uses series-parallel resonant principle.

Furthermore, a commonly used resonant circuit in induction heating is the RLC circuit. However, such a circuit has high losses due to high currents that flow through the components at oscillating frequency. Furthermore, its components need to be large and are expensive.

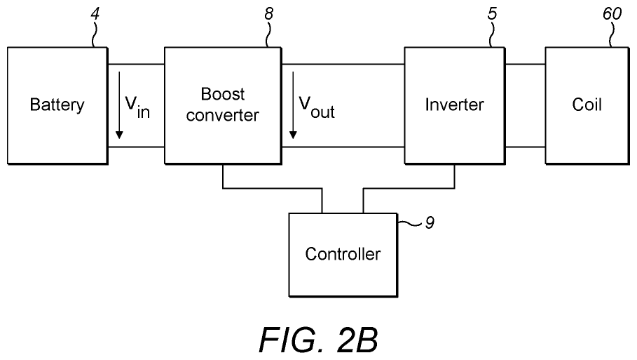

To address these disadvantages, other circuits such as the ones represented on FIGS. 3a, 3b, 3c can be used. Indeed, LLC, LCL and CLL circuits can be used instead of the standard RLC circuit.

LLC, LCL, and CLL circuits have the minimum current draw at resonant frequency operation if operating in parallel resonance and have limited in-rush current. This allows scaling down the components of the circuit to lower values and using smaller components.

These circuits can be digitally controlled, which allows implementation of a measurement of the resonant frequency.

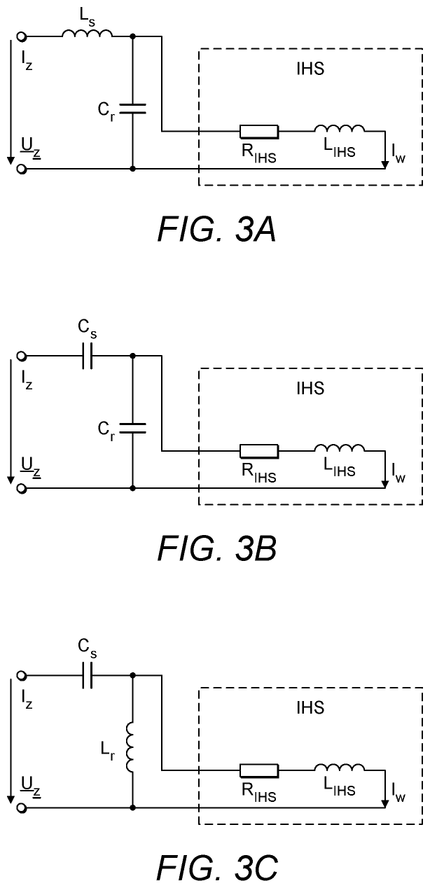

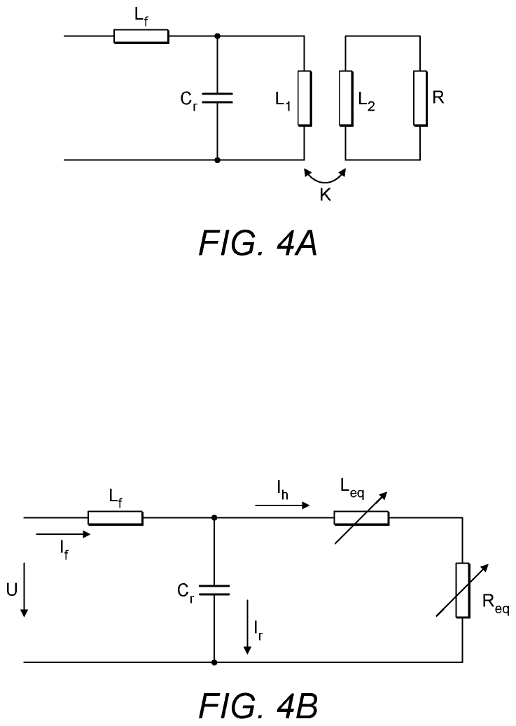

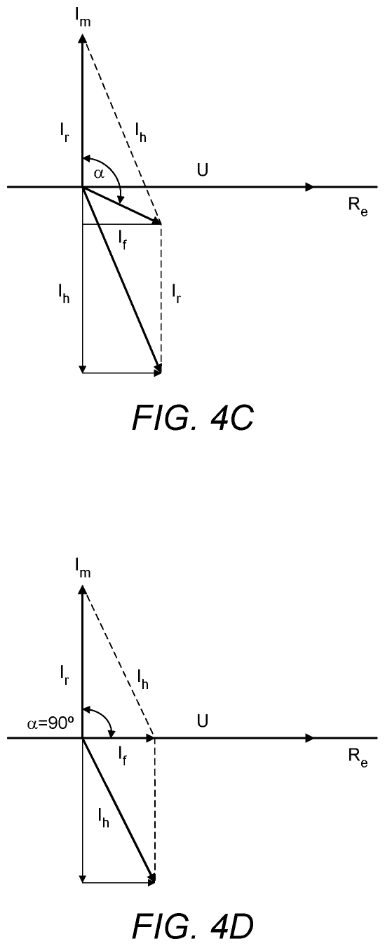

FIG. 4a represents an example of an oscillating circuit of the aerosol-generating device. This oscillating circuit is used for theoretical explanation before explaining the heating control in the aerosol-generating device. The equivalent circuit of induction heating is further transferred to a yet simpler circuit in FIG. 4b.

In order to determine the frequency of the oscillating circuit, it is necessary to determine an indicative electrical value of the oscillating circuit. The indicative electrical value can be any value that is a function of the operating frequency fₒₚ at which the inverter 5 is driving the oscillating circuit. The indicative electrical value can be for example a current, a voltage or an impedance.

In the present embodiment, the indicative electrical value is voltage. The specific reason is that a parallel resonant circuit is implemented. However, as stated above, voltage or impedance can be used as an indicative electrical value depending on the type of oscillating circuit implemented in the system.

The indicative electrical value in the oscillating circuit can be determined using sensors. In the embodiment of FIG. 2a, a voltage sensor 10 is positioned to read the voltage value across the capacitor of the oscillating circuit 6.

The resonant frequency fᵣ of the oscillating circuit is influenced by the values of inductance L, resistance R and capacitance C, and is given as follows:

$${f}_{r} = \frac{1}{2 π} \sqrt{\frac{1}{LC} - {( \frac{R}{L} )}^{2}}$$

The resonant frequency fᵣ of the oscillating circuit depends:
on the exact positioning of the susceptor 7 with respect to the inductance coil 60 of the oscillating circuit 6; and
on the resistance of the susceptor 7 which varies with the temperature of the susceptor. This variation of the resistance can also be influenced by the manufacturing tolerance.

Therefore, the resonant frequency determined during the power delivery mode can be used to track the change in total resistance and thus the temperature of the susceptor 7.

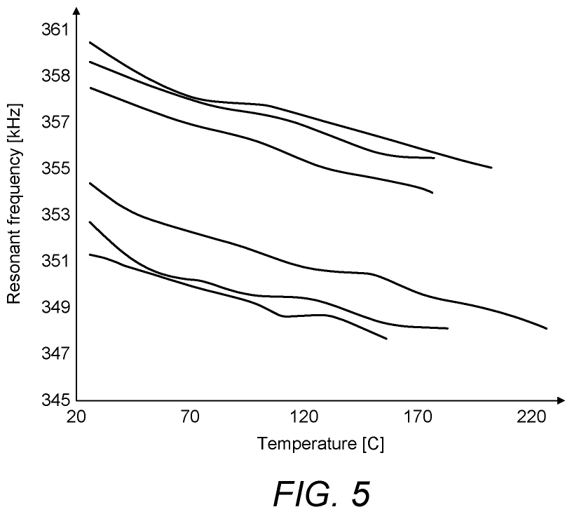

More specifically, the resonant frequency fᵣ varies linearly with the temperature as shown in FIG. 5. A functional form describing the temperature T of the susceptor 7 as a function of frequency characteristic F can be written as F(T)=aT+b, where ‘a’ and ‘b’ are constant parameters of the functional form. The parameter ‘a’ corresponds to the slope value of the curve of frequency. The parameter ‘b’ corresponds to the y-intercept. The functional form can also be a polynomial function. However, in practice the circuitry will normally be optimized such that the aerosol-generating device is operated in a linear area, i.e., a localized linear area of the polynomial function.

The different curves of FIG. 5 represent the variation of the frequency of the oscillating circuit as a function of the temperature and of the position of the susceptor 7. Indeed, as explained above, the resonant frequency depends on the position of the susceptor 7 with respect to the oscillating circuit. This therefore modifies the y-intercept of the curve of the frequency. This appears clearly on FIG. 5 where the slope a is the same for all the curves and the y-intercept is different from one curve to another.

In the illustrated embodiment, the y-intercept or b parameter corresponds to an initial resonant frequency fᵢ of the resonant circuit. The initial resonant frequency fᵢ shall refer to the resonant frequency of the oscillating circuit before heating of the susceptor 7. In other words, it corresponds to resonant frequency when the susceptor 7 is at ambient temperature, i.e. around 20° C.

The illustrated curves thus show that it is possible to take into account an improper insertion of the susceptor 7 in the aerosol-generating device.

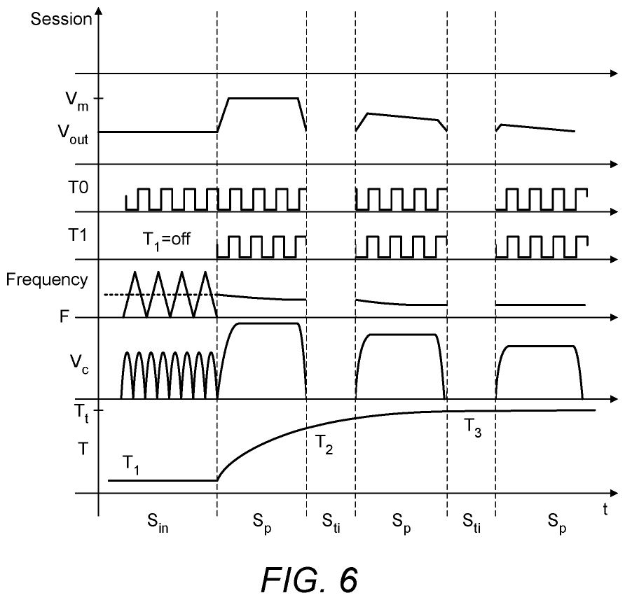

The method for controlling heating of the susceptor 7 of the aerosol-generating device 1 according to an embodiment of the present disclosure is now described with reference to FIG. 6. On this figure, T refers to the temperature of the susceptor 7, V_{c} the voltage across the capacitor of the oscillating circuit, T0, T1 are the two transistors of the inverter 5, the frequency F of the oscillating circuit 6, and Vₒᵤₜ is the output voltage delivered by the boost converter 8. All these parameters are represented as a function of time and with the exception of the susceptor temperature, are shown only for the initialization step Sᵢₙ and the power delivery mode Sₚ.

First, the initial resonant frequency fᵢ of the oscillating circuit is determined. This first step is referenced as Sᵢₙ on FIG. 6 and also referred to as an initialization step. The initialization step Sᵢₙ is performed when the susceptor 7 is at ambient temperature, i.e. before heating it.

For determining the initial resonant frequency fᵢ, a low power energy is supplied to the oscillating circuit. In particular, only the transistor T0 of the inverter 5 operates, the transistor T1 being off. The output voltage Vₒᵤₜ of the boost converter is set to a low value, preferably equal to or less than a predetermined voltage, e.g. about 8V.

Reducing power delivered to the oscillating circuit 6 enables avoiding power delivery to the susceptor 7.

Then, the frequencies are swept on a range and an indicative electrical value in the oscillating circuit is measured. In practice, the initial resonant frequency fᵢ is selected as the frequency when an extremum of the indicative electrical value is obtained.

An extremum shall mean a minimum or a maximum depending on the type of indicative electrical value that is determined. The resonant frequency corresponds to a maximum voltage or current value, and to a minimum impedance value.

Preferably, the swipe in a range lasts a short period. For example, the swipe lasts at most 50 ms.

Preferably, the frequency swipe is performed several times, for example 4 to 12 times. The determined initial resonant frequency fᵢ is the average value of the obtained resonant frequencies during the multiple swipes.

The operating frequency fₒₚ of the inverter 5 is then set at the determined initial resonant frequency fᵢ.

The method for controlling the heating of the susceptor 7 further comprises a power delivery mode Sₚ. The method also comprises here a temperature identification mode S_{Ti}.

The power delivery mode Sₚ is performed during heating of the susceptor 7. During this mode, both transistors T0, T1 of the inverter 5 are operated, typically with a duty cycle of 50%. The output voltage Vₒᵤₜ is normally set to a high value. Namely, the output voltage Vₒᵤₜ is set at a desired output voltage. The desired output voltage will be sufficient to generate appropriate losses in the susceptor for required heating and in some aspects the desired voltage may be a value greater than 8V. The desired output voltage may depend on the susceptor properties such as resistance, shape and size etc.

While heating the susceptor 7, the resonant frequency is continuously tracked. Indeed, resonant frequency changes during the functioning of the aerosol-generating device. Furthermore, operation at the resonant frequency ensures the highest possible energy efficiency. Therefore, the controller tracks the resonant frequency and adjusts the actual operating frequency fₒₚ during heating accordingly.

For doing so, one method, a direct method, can consist in measuring the phase between the current of the inductance coil and the voltage of the capacitor of the oscillating circuit 6. The resonant frequency fᵣ corresponds to the frequency obtained when the current and the voltage are at 90° phase shift.

Another method, an indirect one, can consist in using the electrical measurements in the oscillating circuit, for example current measurements. This method is described with reference to FIG. 4b which represents the equivalent circuit of induction heating, and FIGS. 4c, 4d which are vector representations of the currents in the equivalent circuit respectively when the latter is being close to phase resonance state and in phase resonance state.

As it can be seen in FIG. 4c, when being close to resonance state, the following relationship is obtained: Iₕ²=Iᵣ³+I_{f}²−2IᵣI_{f} cos(α), where I_{f} is the inverter current, Iᵣ is the resonant capacitor current, Iₕ is the induction coil current, and α is a phase angle.

As can be seen in FIG. 4d, in resonance state, the phase angle α is equal to 90°. The following relationship is thus obtained: Iₕ²=Iᵣ²+I_{f}².

An error function is defined to track the resonance state. The error function is defined as the difference between a measured or actual induction coil current squared value and the resonant induction coil current squared value. In other words, the error function is expressed as follows: ε=Iₕ²−(Iᵣ²+I_{f}²). It can be also expressed as:

ε=Iᵣ²+I_{f}²−2IᵣI_{f} cos(α)−(Iᵣ²+I_{f}²).

The error function can be simplified as follows: ε=−2IᵣI_{f} cos(α).

Therefore, in resonance state when α=90°, the error ε is equal to zero.

When being close to resonance state, the currents can be considered as sinusoidal peak values. The error function can thus be rewritten as follows:

$$ε = \frac{1}{\sqrt{2}} ( {I}_{h , peak}^{2} - ( {I}_{r , peak}^{2} + {I}_{f , peak}^{2} ) .$$

The induction heating system can further comprise an estimator which drives the controller 9 and that is adapted to minimize this error function.

In power delivery mode, as long as the susceptor 7 is being heated, the resonant frequency is tracked and the operating frequency fₒₚ of the inverter 5 is being set to the resonant frequency fᵣ. The operating frequency fₒₚ is thus continuously updated in order to correspond to the resonant frequency of the oscillating circuit.

Thanks to such a configuration, the highest possible energy efficiency is ensured.

In an embodiment, the controller or the aerosol-generating device can comprise a memory adapted to store one or a plurality of values of the determined resonant frequency fᵣ.

For example, the determined resonant frequency can be stored. Then, when updating the resonant frequency, the generated frequency can be swept around the stored resonant frequency. At each generated frequency, the indicative electrical value is compared to the value corresponding to the previously stored resonant frequency. The generated frequency is overwritten if the voltage/current is higher, or the impedance is lower than the one corresponding to the previously stored resonant frequency.

Since the resonant frequency is continuously tracked during the power delivery mode Sₚ, the temperature can be continuously determined using the curves of FIG. 5. In practice, the same corresponding curve of the initial resonant frequency is used for determining the temperature of the susceptor.

The curves as represented at FIG. 5 are adapted after initial resonant frequency determination. The curves can be then shifted or not depending on the equation implemented in the controller.

In another embodiment the curves can be implemented as a look-up table. The look-up table can be registered in the memory of the aerosol-generating device.

In an embodiment of the present disclosure, the controller or the aerosol-generating device comprises a memory configured to store data comprising the parameters of the functional form describing the temperature as a function of the frequency characteristic and the position of the susceptor 7.

In practice, once the initial resonant frequency fᵢ is known, the corresponding curve is selected using the fact that the resonant frequency at ambient temperature is equal to the initial resonant frequency fᵢ. The initial resonant frequency fᵢ thus represents a reference frequency which enables the selection of the curve for determination of the temperature of the susceptor 7.

Then, the temperature of the susceptor 7 can be determined thanks to the resonant frequency value by simple reading on the corresponding curve. The temperature is thus updated while the resonant frequency is updated during heating of the susceptor 7 during the power delivery mode Sₚ.

Using this method for controlling the heating, the temperature of the susceptor 7 can be continuously determined during power delivery mode Sₚ.

The power delivery mode Sₚ and the temperature identification mode S_{Ti} are alternated.

The temperature identification mode S_{Ti} can be repeated for example at regular intervals.

In the represented example, the power delivery mode Sₚ and the temperature identification mode S_{Ti} are regularly repeated and alternated. But the duration of the power delivery mode Sₚ and the temperature identification mode S_{Ti} may vary during functioning of the aerosol-generating device. It may be beneficial to reduce how often the temperature identification modes S_{Ti} are carried out depending on the operating factors. For example, it may be beneficial to extend the length of the power delivery mode Sₚ during early phases of heat-up and this would reduce the frequency at which the temperature identification modes S_{Ti} are carried out.

The power supply can be regulated using any appropriate means. For example, power is regulated using the boost converter 8 connected between the battery 4 and the inverter 5.

An example of power supply regulation is represented in FIG. 6. On this figure, the temperature T of the susceptor 7 increases with time thanks to induction heating. The temperature of the susceptor 7 increases until reaching the predefined or target temperature Tₜ.

It shall be understood that the controller or the aerosol-generating device can be configured to store the predefined or target temperature of the susceptor 7. The same memory as the one used to store data comprising the parameters of the functional form describing the temperature as a function of the frequency, can be used. The controller or the aerosol-generating device can also comprise a comparator that compares the determined temperature to the stored target temperature.

As long as the determined temperature is below the target temperature, the power supply to the inverter 5 is maintained and the susceptor 7 continues to be heated. When the target temperature Tₜ is approached, the power supply can be reduced. Once the target temperature is reached, the power supply is interrupted or set very low.

More precisely, in the first represented power delivery mode Sₚ, the voltage is boosted until reaching a maximum voltage value Vₘ while the temperature increases but remains lower than the target temperature Tₜ. In the second power delivery mode Sₚ, the boost voltage is reduced as the temperature of the susceptor 7 approaches the target temperature Tₜ. Then, in the third power delivery mode Sₚ, the boost voltage value is reduced and preferably approaches a value around 8V, for example.

In other words, in the represented example, the controller 9 applies the adequate output voltage Vₒᵤₜ to the inverter to bring the temperature of the susceptor 7 to the desired temperature. Other ways of controlling the heating of the susceptor 7 can also be used, including the “global” PWM control scheme mentioned above which does not require use of the boost converter 8 to boost the voltage.

Temperature of the susceptor 7 is here controlled using a smooth (slow or overdamped) control. In other words, the controller 9 is tuned to be overdamped. Overdamped shall mean that the damping ratio is strictly greater than 1.

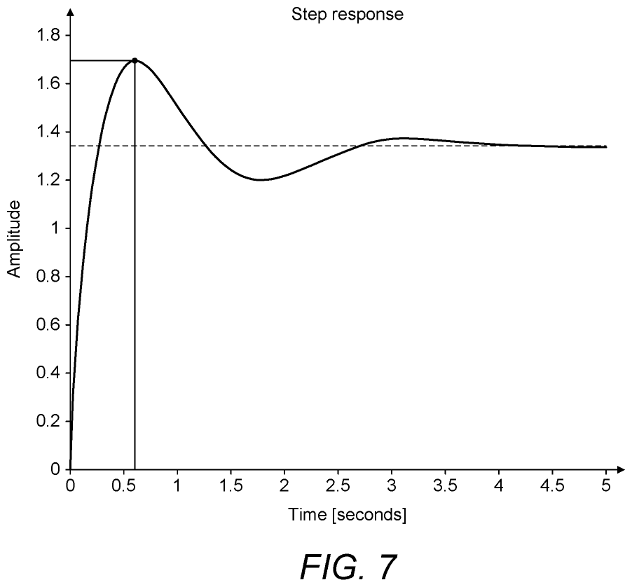

Other ways of controlling temperature, i.e. different from an overdamped control, can also be used. For example, and as illustrated in FIG. 7, temperature of the susceptor 7 can be controlled using a fast underdamped control. In other words, the controller 9 is tuned to be underdamped. Underdamped shall mean that the damping ratio is strictly less than 1. The controller 9 thus overshoots slightly to reach the target temperature Tₜ more quickly. The controller 9 can be configured to overshoot the temperature of the susceptor 7 for a short period of time at the beginning of use of the aerosol-generating device, namely at the pre-heating.

Furthermore, the identification of the temperature using the described method avoids the need to use sensors. Using sensors to measure the temperature of the susceptor, as it is done in the prior art, has several drawbacks such as the following:
when temperature of the susceptor is measured, there is an inaccuracy between the temperature of the susceptor and that of the heated aerosol-generating product;
when the temperature of the susceptor is measured, it is very challenging to make sure that the sensor is in close contact with the susceptor and that there are no thermal residues;
accurate temperature sensors are expensive and require a calibration process as well as additional electronic circuitry to make them precise.

Moreover, the method for controlling the heating according to the present disclosure is a contactless method, i.e. no physical contact with the susceptor is needed. This makes the method for controlling the heating of the susceptor simpler and cost-efficient.

It should be understood that various changes and modifications to the presently preferred embodiments described herein will be apparent to those skilled in the art. Such changes and modifications can be made without departing from the spirit and scope of the present disclosure and without diminishing its attendant advantages. It is therefore intended that such changes and modifications be covered by the appended claims.

For example, it will be appreciated that other functional forms may be used for the dependency between the resonant frequency and the temperature of the susceptor. For example non-linear functional forms such as polynomial functions parameterized as appropriate can be used.

The present disclosure thus provides a method for controlling inductive heating in an aerosol-generating device that enables optimizing energy efficiency.

The determination of the resonant frequency of the oscillating circuit and temperature of the aerosol-generating product is applicable for any type of susceptor, and takes account of differences in the placement of the susceptor relative to the inductor. Moreover, the temperature determination is compliant with changes of the susceptor, or of any component of the oscillating circuit, the latter being replaceable, for example after a certain use, or after damage.

Any combination of the above-described features in all possible variations thereof is encompassed by the present disclosure unless otherwise indicated herein or otherwise clearly contradicted by context.

Unless the context clearly requires otherwise, throughout the description and the claims, the words “comprise”, “comprising”, and the like, are to be construed in an inclusive as opposed to an exclusive or exhaustive sense; that is to say, in the sense of “including, but not limited to”.

References used for the figures

| | |
|---|---|
| 1 | Aerosol-generating device |
| 2 | Main body |
| 3 | Cartridge |
| 30 | First end of the cartridge |
| 31 | Second end of the cartridge |
| 32 | Reservoir |
| 320 | Lateral walls of the reservoir |
| 33 | Aerosol-generating product |
| 4 | Battery |
| 40 | Battery circuitry |
| 5 | Inverter |
| 50 | Inverter circuitry |
| 6 | Oscillating circuit |
| 60 | Coil |
| 61 | Coil circuit |
| 62 | Susceptor circuit |
| 7 | Susceptor |
| Tt | Target temperature of the susceptor |
| 8 | Boost converter |
| 80 | Boost converter circuitry |
| 81 | Inductor of the boost converter |
| 82 | Capacitor of the boost converter |
| 9 | Controller |
| 10 | Voltage sensor |
| T2 | Active switch of the boost converter |
| T3 | Passive switch of the boost converter |
| Vᵢₙ | Input voltage of the boost converter |
| Vₒᵤₜ | Output voltage of the boost converter |
| fₒₚ | Operating frequency |
| fᵢ | Initial resonant frequency |
| fᵣ | Resonant frequency |
| T0, T1 | Transistors of the inverter |
| Sᵢₙ | Initialization step |
| Sₚ | Power delivery mode |
| S_{Ti} | Temperature identification mode |

1. A method for controlling heating of a susceptor of an aerosol-generating device, the susceptor being inductively heated by an oscillating circuit driven by an inverter at an operating frequency, wherein said method comprises a power delivery mode of the aerosol-generating device, a step of updating the operating frequency being performed during the power delivery mode and comprising the following sub-steps:
determining, using a controller, a resonant frequency of the oscillating circuit during heating of the susceptor; and
setting, using the controller, the operating frequency at the determined resonant frequency,
said updating step being continuously repeated during the power delivery mode of the aerosol-generating device.

2. The method according to claim 1, wherein the resonant frequency in the updating step is determined by measuring a phase between a current of an inductance coil and a voltage of a capacitor of the oscillating circuit, the resonant frequency corresponding to a frequency obtained when the current and the voltage are at 90° phase shift.

3. The method according to claim 1, wherein the resonant frequency in the updating step is determined by minimizing an error function calculated using measurements of electrical indicative values in the oscillating circuit.

4. The method according to claim 1, wherein the updating step further comprises a sub-step of determining a susceptor temperature based on the determined resonant frequency during the power delivery mode.

5. The method according to claim 4, wherein the temperature of the susceptor during the power delivery mode is determined using a predetermined linear function between the resonant frequency of the oscillating circuit and the temperature of the susceptor.

6. The method according to claim 4, wherein the temperature of the susceptor during the power delivery mode is determined using a predetermined polynomial function between the resonant frequency of the oscillating circuit and the temperature of the susceptor.

7. The method according to claim 1, further comprising a temperature identification mode of the aerosol-generating device.

8. The method according to claim 7, wherein the power delivery mode and the temperature identification mode are alternated during operating of the aerosol-generating device.

9. The method according to claim 7, wherein the temperature identification mode is run at regular intervals of time.

10. The method according to claim 1, further comprising an initialization step comprising the following sub-steps:
determining an initial resonant frequency of the oscillating circuit when the susceptor is at ambient temperature; and
setting the operating frequency at the determined initial resonant frequency.

11. The method according to claim 10, wherein the resonant frequency in the initialization step is determined by:
sweeping frequencies on a range;
measuring an indicative electrical value in the oscillating circuit; and
selecting the resonant frequency within said range when an extremum of said indicative electrical value is obtained.

12. An aerosol-generating device comprising:
an induction heatable susceptor;
an oscillating circuit arranged to generate a time varying electromagnetic field for inductively heating the susceptor;
an inverter configured to drive the oscillating circuit at an operating frequency; and
a controller adapted to implement the method for controlling the heating of the susceptor according to claim 1.

13. The aerosol-generating device according to claim 12, further comprising a boost converter connected between a power supply unit and the inverter.
